(19) United States
(12) Patent Application Publication
(10) Pub. No.: US 2020/0126038 A1
(43) Pub. Date: Apr. 23, 2020

(54) ONLINE SHOPPING SERVICE PROCESSING

(71) Applicant: Alibaba Group Holding Limited, George Town (KY)

(72) Inventor: Jian Sun, Hangzhou (CN)

(73) Assignee: Alibaba Group Holding Limited, George Town (KY)

(21) Appl. No.: 16/722,400

(22) Filed: Dec. 20, 2019

Related U.S. Application Data
(63) Continuation of application No. 16/008,999, filed on Jun. 14, 2018.
Application No. 16/008,999 is a continuation of application No. PCT/CN2016/110317, filed on Dec. 16, 2016.

(30) Foreign Application Priority Data
Dec. 29, 2015 (CN) 201511017669.2

(51) Int. Cl. G06Q 10/08; G06Q 30/06; G06Q 30/02

(52) U.S. Cl. CPC G06Q 10/08345; G06Q 30/0635; G06Q 30/0282; G06Q 30/0611; G06Q 30/0631

(57) ABSTRACT

An order request including a plurality of selected items listed on an online shopping platform is received from a mobile device. A plurality of combinations of suppliers located within a predetermined distance from a delivery address of the order is determined, where each combination of suppliers supplies the plurality of selected items. A price rating of each of the plurality of supplier combinations is determined based on prices of the plurality of selected items offered by the corresponding supplier combination. A recommendation rating of each of the plurality of supplier combinations is determined based on customer review ratings of the plurality of selected items offered by the corresponding supplier combination. A first one or more combinations of suppliers with price ratings that satisfy a first condition and second one or more combinations of suppliers with recommendation ratings that satisfy a second condition are presented to the mobile device.

This application is a continuation of U.S. patent application Ser. No. 16/008,999, filed on Jun. 14, 2018, which is a continuation of PCT Application No. PCT/CN2016/110317, filed on Dec. 16, 2016, which claims priority to Chinese Patent Application No. 201511017669.2, filed on Dec. 29, 2015, and each application is hereby incorporated by reference in its entirety.

### TECHNICAL FIELD

The present application relates to the field of network technologies, and in particular, to a service processing method and apparatus.

### BACKGROUND

With the rapid development of Internet technologies, more and more services can be processed through the Internet, such as online shopping and online food ordering. Currently, a user can order food online from restaurants. For example, a user can usually first choose a restaurant, and then select and order foods offered by the restaurant. However, in such case, the user often needs to switch between restaurants when ordering food, which can be complicated, reduces food ordering efficiency, and unnecessarily consumes processing power of mobile terminals.

### SUMMARY

The present application provides a service processing method and apparatus. Specifically, the present application is implemented by using the following technical solutions.

A service processing method is provided, and the method includes: receiving a product order placed by a user, where the product order includes one or more product identifiers; determining a supplier combination that matches the product identifiers, where the supplier combination includes one or more suppliers; determining a recommendation rating of each supplier combination; and recommending, to the user, a supplier combination with a recommendation rating satisfying a predetermined condition.

Optionally, determining a supplier combination that matches the product identifiers includes: determining a set of suppliers within a predetermined distance from a delivery address; and determining the supplier combination that matches the product identifiers from the set of suppliers.

Optionally, the recommendation rating includes a price recommendation rating and a review recommendation rating; and recommending, to the user, a supplier combination with a recommendation rating satisfying a predetermined condition includes: recommending, to the user, a first supplier combination with a price recommendation rating satisfying a first condition and a second supplier combination with a review recommendation rating satisfying a second condition.

Optionally, when the recommendation rating is a price recommendation rating, the determining of a recommendation rating of each supplier combination includes: products that correspond to all the product identifiers in the product order, calculating a difference between a quoted price and an average price of the supplier combination, and using the difference as the price recommendation rating of the supplier combination.

Optionally, when the recommendation rating is a review recommendation rating, the determining of a recommendation rating of each supplier combination includes: products that correspond to all the product identifiers in the product order, obtaining a product review score of the supplier combination; and calculating an average review score of the supplier combination for all the products in the product order based on the product review score, and using the average review score as the review recommendation rating of the supplier combination.

A service processing apparatus is provided, and the apparatus includes: an instruction receiving unit, configured to receive a product order placed by a user, where the product order includes one or more product identifiers; a combination determining unit, configured to determine a supplier combination that matches the product identifiers, where the supplier combination includes one or more suppliers; a rating determining unit, configured to determine a recommendation rating of each supplier combination; and a combination recommendation unit, configured to recommend, to the user, a supplier combination with a recommendation rating satisfying a predetermined condition.

Optionally, the combination determining unit specifically determines a set of suppliers within a predetermined distance from a delivery address, and determines the supplier combination that matches the product identifiers from the set of suppliers.

Optionally, the recommendation rating includes a price recommendation rating and a review recommendation rating; and the combination recommendation unit specifically recommends, to the user, a first supplier combination with a price recommendation rating satisfying a first condition and a second supplier combination with a review recommendation rating satisfying a second condition.

Optionally, when the recommendation rating is a price recommendation rating, for products that correspond to all the product identifiers in the product order, the rating determining unit specifically calculates a difference between a quoted price and an average price of the supplier combination, and uses the difference as the price recommendation rating of the supplier combination.

Optionally, when the recommendation rating is a review recommendation rating, for products that correspond to all the product identifiers in the product order, the rating determining unit specifically obtains a product review score of the supplier combination, calculates an average review score of the supplier combination for all the products in the product order based on the product review score, and uses the average review score as the review recommendation rating of the supplier combination.

It can be seen that the serving terminal in the present application can determine, for a user, a supplier combination that matches product identifiers in a product order of the user, and recommend, to the user, a supplier combination with a recommendation rating satisfying a predetermined condition, so that the user can select from. In the entire process, the user only needs to select a product, the serving terminal recommends, to the user, a supplier combination that matches the product, and the user does not need to switch between a plurality of suppliers. Therefore, online selection efficiency is improved, and processing resources of a user terminal are saved.

### BRIEF DESCRIPTION OF DRAWINGS

FIG. 1 is a flowchart illustrating an example of a service processing method, according to an implementation of the present application.

FIG. 2 is a flowchart illustrating another example of service processing method, according to an implementation of the present application.

FIG. 3 is a structural diagram illustrating an example of a service processing apparatus, according to an implementation of the present application.

FIG. 4 is a structural diagram illustrating an example of a service processing apparatus, according to an implementation of the present application.

FIG. 5 is a flowchart illustrating an example of a computer-implemented method for online shopping service processing, according to an implementation of the present disclosure.

### DESCRIPTION OF EMBODIMENTS

Example implementations are described in detail here, and the examples are presented in the accompanying drawings. For the accompanying drawings described in the following descriptions, unless otherwise specified, same numbers in different accompanying drawings represent the same or similar elements. Implementations described in the following examples do not represent all implementations in accordance with the present application. Instead, they are merely examples of apparatus and methods in accordance with some aspects of the present application that are referred to in the appended claims.

The terms used in the present application are merely for describing specific implementations, and are not intended to limit the scope of the present application. The terms “a” and “the” of singular forms used in the present application and the appended claims are also intended to include plural forms, unless otherwise specified in the context.

It should be understood that, the term “and/or” used here indicates any or all possible combinations including one or more related listed items.

It should be understood that although the terms “first”, “second”, “third”, etc. may be used in the present application to describe various information, the information is not limited by the terms. These terms are only used to differentiate information of the same type. For example, without departing from the scope of the present application, first information can also be referred to as second information, and similarly, second information can also be referred to as first information. Depending on the context, for example, the word “if” used here can be explained as “while” or “when” or “based on determining that”.

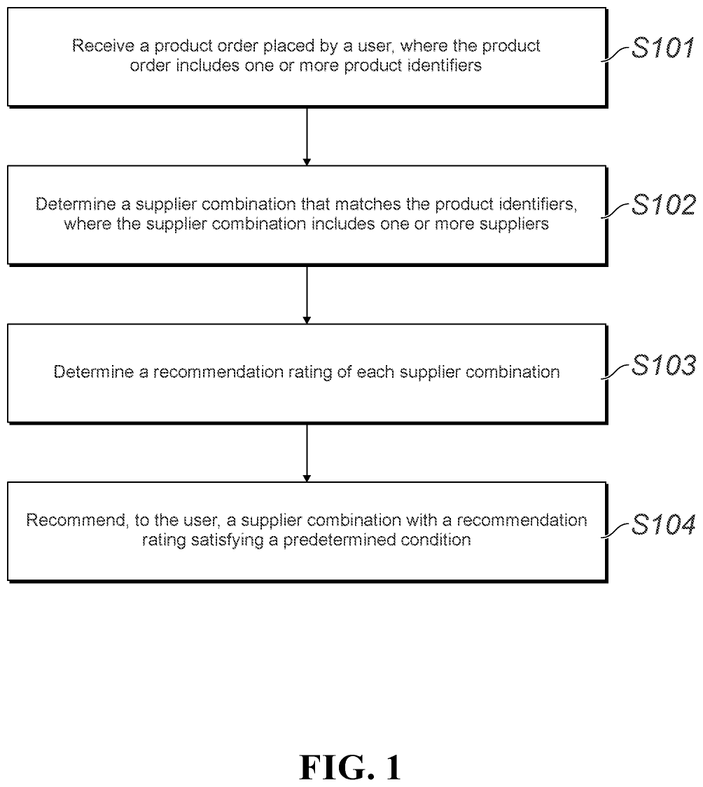

FIG. 1 is a flowchart illustrating an example of a service processing method, according to an implementation of the present application.

Referring to FIG. 1, the service processing method can be applied to a serving terminal, and the serving terminal can be a server or a server cluster of an online shopping platform. The service processing method can include the following steps.

Step 101: Receive a product order placed by a user, where the product order includes one or more product identifiers.

In this implementation, the user can view a product list provided by an online shopping platform, and place the product order based on the product list. The product list includes products provided by suppliers. For example, if supplier A provides product A1 and product A2, and supplier B provides product B1 and product B2, the product list includes products A1, A2, B1, and B2.

The user can select products based on the product list, and place the product order after selecting the products. The product order includes product identifiers of one or more products selected by the user, and each product identifier corresponds to a unique product.

In this implementation, the products can include conventional physical products purchased online, such as clothes and furniture. The products can also include products that require high instantaneity, such as food. Types of products are not limited in the present application.

Step 102: Determine a supplier combination that matches the product identifiers, where the supplier combination includes one or more suppliers.

Based on step 101, after receiving the product order, the serving terminal can determine the supplier combination that matches the product identifiers. For example, the serving terminal can first determine, based on a delivery address of the user, a set of suppliers within a predetermined distance from the delivery address, and then determine the supplier combination that matches the product identifiers from the set of suppliers.

Step 103: Determine a recommendation rating of each supplier combination.

Based on step 102, after determining the supplier combination that matches the product identifiers, the serving terminal can determine the recommendation rating of each predetermined combination. The recommendation rating can include a price recommendation rating, a review recommendation rating, etc.

Step 104: Recommend, to the user, a supplier combination with a recommendation rating satisfying a predetermined condition.

Based on step 103, the serving terminal can recommend, to the user, the supplier combination with a recommendation rating satisfying the predetermined condition, so that the user can select from.

It can be seen from the previous descriptions that the serving terminal in the present application can determine, for a user, a supplier combination that matches product identifiers in a product order of the user, and recommend, to the user, a supplier combination with a recommendation rating satisfying a predetermined condition, so that the user can select from. During the process, the user selects the products, the serving terminal recommends, to the user, a supplier combination that matches the products. The user does not need to switch between suppliers. Therefore, online ordering efficiency can be improved, and processing resources of the user terminal can be saved.

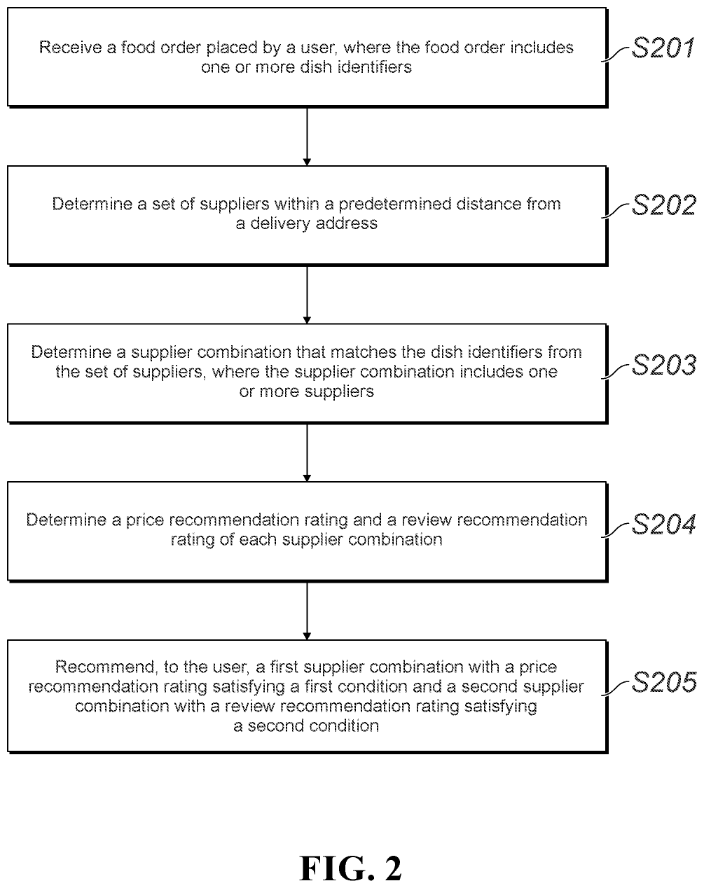

FIG. 2 is a flowchart illustrating another example of a service processing method, according to an implementation of the present application.

Referring to FIG. 2, in this implementation, for example, a product is a food order. The product order is a food order, the product identifiers are identifiers of foods, and the product list is a food menu. The service processing method can be applied to a serving terminal, and the serving terminal can be a server or a server cluster of an online food ordering platform. The service processing method can include the following steps.

Step 201: Receive a food order placed by a user, where the food order includes one or more dish identifiers.

In this implementation, a food supplier such as a restaurant or an eatery can register with an online food ordering platform. After successfully registering with the online food ordering platform, the supplier can upload information such as location information, dishes provided, and prices of the dishes to the serving terminal. The serving terminal can generate a menu for the user with reference to dishes provided by suppliers. In this implementation, the serving terminal can determine how to generate the menu according to related technologies. For example, the menu can include Chinese food and Western food, and Chinese food menu can further include cold dishes, hot dishes, specialty food, etc. Certainly, in actual implementations, the serving terminal can also generate a menu by using another method that is not limited in the present application.

In this implementation, when ordering food online, the user can first view a menu provided by the serving terminal, select a dish on the menu, and place a food order after selecting the dish. The food order includes dish identifiers of one or more dishes selected by the user, and the dish identifier corresponds to a unique dish. For example, if the user selects dishes “seasoned cucumber” and “braised bass”, the food order includes a dish identifier of “seasoned cucumber”, such as identifier A, and a dish identifier of “braised bass”, such as identifier B.

Step 202: Determine a set of suppliers within a predetermined distance from a delivery address.

In this implementation, the serving terminal can determine the set of suppliers based on the delivery address of the user. For example, the set of suppliers can include all suppliers within 3 kilometers or 5 kilometers from the delivery address. Specifically, the serving terminal can determine the set of suppliers based on the delivery address and address information provided by the suppliers during registration.

In this implementation, the delivery address can be included in the food order, and after receiving the food order, the serving terminal can determine the set of suppliers based on the delivery address included in the food order. The delivery address can be determined before the user places the food order. For example, after logging to an online food ordering platform, the user first selects a delivery address, a client terminal sends the delivery address to the serving terminal, and the serving terminal can determine a set of suppliers after receiving the delivery address. In this case, the serving terminal first performs step 202, and then performs step 201. The present application is not limited to this implementation.

Step 203: Determine a supplier combination that matches the dish identifiers from the set of suppliers, where the supplier combination includes one or more suppliers.

In this implementation, the serving terminal can exhaust each supplier in all supplier combinations to determine a supplier combination that matches the dish identifiers. Optionally, the serving terminal can first select a supplier, and then determine whether the supplier matches all the dish identifiers included in the food order. If the supplier matches all the dish identifiers included in the food order, the serving terminal can determine the supplier as the supplier combination. In other words, the supplier combination includes one supplier. If the supplier matches some dish identifiers included in the food order, the serving terminal can select, from other suppliers, one or more suppliers that match other dish identifiers included in the food order, to form a supplier combination that matches all the dish identifiers included in the food order. In other words, the supplier combination includes a plurality of suppliers.

For example, the dish identifiers included in the food order are identifier A and identifier B. If dishes provided by supplier 1 include “seasoned cucumber” and “braised bass”, the serving terminal can determine that supplier 1 matches identifier A and identifier B included in the food order, and determine supplier 1 as a supplier combination. If dishes provided by supplier 2 include “seasoned cucumber”, but does not include “braised bass”, the serving terminal can determine that supplier 2 matches identifier A, but does not match identifier B, and the serving terminal can select a supplier that matches identifier B from other suppliers in the set of suppliers, that is, a supplier that provides “braised bass”, for example, supplier 3. Supplier 3 and supplier 2 are another supplier combination that matches all the dish identifiers in the food order.

In actual implementation, the maximum number of suppliers that can be included in a supplier combination can be predetermined. Specifically, a maximum number of suppliers can be set to, for example, 3. In other words, each supplier combination includes a maximum of three suppliers. The maximum number of suppliers that dynamically changes can alternatively be set based on the number of dish identifiers included in the food order. For example, when the number of dish identifiers included in the food order is less than or equal to 5, the maximum number of suppliers can be set to 3. However, when the number of dish identifiers included in the ordering instruction is greater than 5 and less than 10, the maximum number of suppliers can be set to 4, etc. The present application is not limited to this implementation.

In this implementation, the serving terminal can determine one or more supplier combinations from the set of suppliers, and each supplier combination includes one or more suppliers.

Step 204: Determine a price recommendation rating and a review recommendation rating of each supplier combination. In this implementation, the serving terminal can sequentially determine price recommendation ratings and review recommendation ratings of all the supplier combinations.

The price recommendation rating is used to measure a price of the supplier combination. Specifically, the serving terminal can calculate a quoted price from a supplier combination based on dishes that correspond to the dish identifiers in the food order. The serving terminal further calculates an average price of the dishes that correspond to all the dish identifiers associated with the dishes in the food order, then calculates a difference between the quoted price and the average price, and uses the difference as the price recommendation rating.

For example, the dish identifiers included in the previous food order are identifier A and identifier B, the user selects “seasoned cucumber” and “braised bass”, the supplier combination is supplier 2 and supplier 3, supplier 2 provides “seasoned cucumber”, and supplier 3 provides “braised bass”. Therefore, the quoted price of the supplier combination is the sum of the price quoted by supplier 2 for “seasoned cucumber” and the price quoted by the supplier 3 for “braised bass”. For simplicity of description, M is used to represent the quoted price. The serving terminal further calculates an average price of “seasoned cucumber” and “braised bass”. For example, the serving terminal can obtain prices quoted by all suppliers at an online food ordering platform for “seasoned cucumber”, and then calculate an average quoted price for “seasoned cucumber”. Likewise, the serving terminal also calculates an average quoted price for “braised bass”, and adds up the two average prices to obtain an average price of “seasoned cucumber” and “braised bass”. For simplicity of description, P is used to represent the average price. Optionally, the difference between the quoted price and the average price can be a difference between M and P, or can be a quotient of M divided by P. The present application is not limited to this implementation.

The review recommendation rating can reflect reviews of other users on a dish that matches a dish identifier that is provided by the supplier combination. Specifically, for each dish corresponding to each dish identifier in the food order, the serving terminal can first obtain dish review scores from the supplier combination, calculate an average review score of the dishes in the food order, and use the average review score as the review recommendation rating of the supplier combination.

For example, the dish identifiers included in the previous food order are identifier A and identifier B, the user selects “seasoned cucumber” and “braised bass”, the supplier combination is supplier 2 and supplier 3, supplier 2 provides “seasoned cucumber”, and supplier 3 provides “braised bass”. The serving terminal can obtain a dish review score of “seasoned cucumber” provided by supplier 2, such as X1, and a dish review score of “braised bass” provided by supplier 3, such as X2, and then divide the sum of the two dish review scores by the number of dishes, to obtain an average review score. The average review score is equal to (X1+X2)/2.

Step 205: Recommend, to the user, a first supplier combination with a price recommendation rating satisfying a first condition and a second supplier combination with a review recommendation rating satisfying a second condition.

Based on step 204, after determining the price recommendation rating and the review recommendation rating of each supplier combination, the serving terminal can recommend, to the user, the first supplier combination with a price recommendation rating satisfying the first condition and the second supplier combination with a review recommendation rating satisfying the second condition. In this implementation, the first condition and the second condition can be predetermined by a developer. To recommend a supplier combination that provides attractive prices and quality to the user, the first supplier combination with a price recommendation rating satisfying the first condition can often be a supplier combination that offers a lower price, and the second supplier combination with a review recommendation rating satisfying the second condition can often be a supplier combination with good reviews.

For example, the price recommendation rating is P/M. If the price recommendation rating is less than 1, it indicates that the quoted price of the supplier combination is greater than the average price, and the quoted price is relatively high. If the price recommendation rating is greater than 1, it indicates that the quoted price of the supplier combination is less than the average price, and the quoted price is relatively low. In this implementation, the first condition can be set as a price recommendation rating is greater than 1, or one of the top N1 price recommendation ratings, where N1 is a natural number greater than or equal to 1, so that the first supplier combination satisfying the first condition is a supplier combination with a relatively low price.

In addition, for the review recommendation rating, the second condition can be set as having the highest review recommendation rating, or top N2 review recommendation rankings, where N2 is a natural number greater than 1, so that the second supplier combination that satisfies the second condition is a supplier combination with one of the best reviews.

In this implementation, after determining the first supplier combination with a price recommendation rating satisfying the first condition and the second supplier combination with a review recommendation rating satisfying the second condition, the serving terminal can recommend the first supplier combination and the second supplier combination to the user.

For example, after the user places the food order, the serving terminal determines all supplier combinations that match the dish identifiers, and determines the first supplier combination and the second supplier combination from all the supplier combinations. When all the supplier combinations are returned to the user, the first supplier combination and the second supplier combination are used as preferred supplier combinations and recommended to the user.

It can be seen from the previous descriptions that the serving terminal in the present application can determine, for the user, the supplier combination that matches the dish identifiers in the food order of the user, and recommend, to the user, a supplier combination with a recommendation rating satisfying a predetermined condition, so that the user can select from. During the process, the user only needs to select the dishes, the serving terminal recommends, to the user, a supplier combination that matches the dishes, and the user does not need to switch between a plurality of suppliers. Therefore, online food ordering efficiency can be improved, and processing resources of a user terminal can be saved. The implementation process of the present application is described below with reference to a specific application scenario.

Assume that Xiao Ming invited his friends over, and they decide to order takeout for dinner. An out-of-province friend wants to eat authentic Hangzhou food, but a local friend wants to eat pizza. Xiao Ming opens a third-party food ordering platform through a mobile phone to select Hangzhou cuisine from a menu provided by the platform, and select Fish with West Lake Style, Beggar's Chicken, Madam Sung's Fish Chowder, etc. from a list of Hangzhou dishes. Xiao Ming can also select Western food from the menu provided by the platform, and select Western-style food such as Seafood Pizza and Caesar Salad from a list of Western foods. After selecting the dishes, Xiao Ming can place a food order. The platform can determine, based on the food order, a supplier combination that matches all the dishes selected by Xiao Ming, and determine a recommendation rating of each supplier combination. Assume that a supplier combination with a recommendation rating satisfying a predetermined condition is “Chang's Garden” and “Pizza Hut”. The platform can recommend “Chang's Garden” and “Pizza Hut” to Xiao Ming. Xiao Ming can submit an order by using an ordering option. In the entire process, Xiao Ming does not need to switch between a plurality of restaurants, so that the food ordering efficiency is improved.

In the previous implementation, the third-party ordering platform can implement the previous supplier combination recommendation process by using the service processing solution provided in the method implementation shown in FIG. 1 or FIG. 2. Details are not described here again to avoid duplication in the present application.

Corresponding to the implementations of the previous service processing method, the present application further provides implementations of a service processing apparatus.

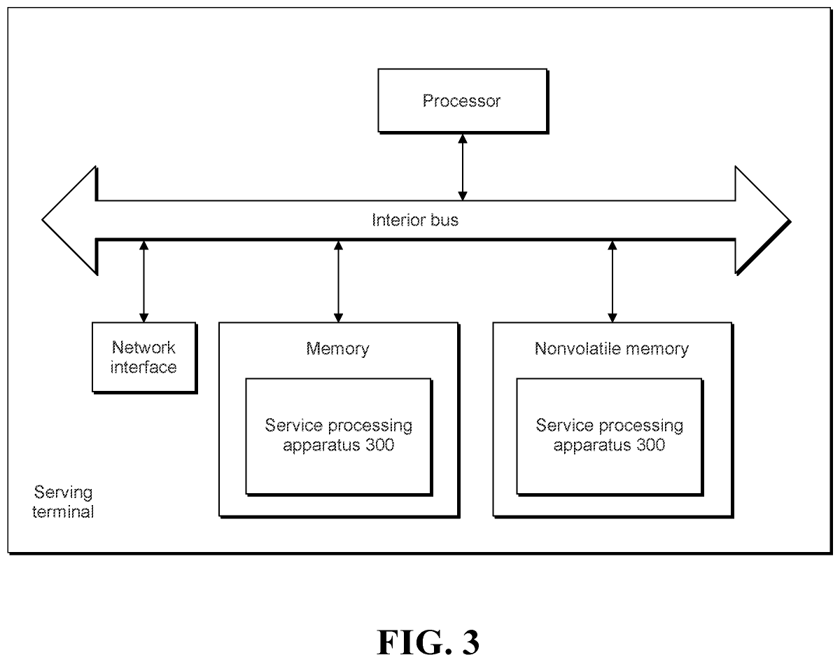

The implementation of the service processing apparatus in the present application can be applied to a serving terminal. The apparatus implementation can be implemented by using software, hardware, or a combination of software and hardware. Software implementation is used as an example. As a logical apparatus, the apparatus functions when a processor at the serving terminal reads a corresponding computer program instruction in a nonvolatile memory into a memory. In terms of hardware, FIG. 3 is a structural diagram illustrating a serving terminal that the service processing apparatus according to the present application is located. In addition to the processor, memory, network interface, and the nonvolatile memory shown in FIG. 3, the serving terminal that the apparatus is located in this implementation can often include other hardware based on actual functions of the serving terminal. Details are not described to avoid redundancy.

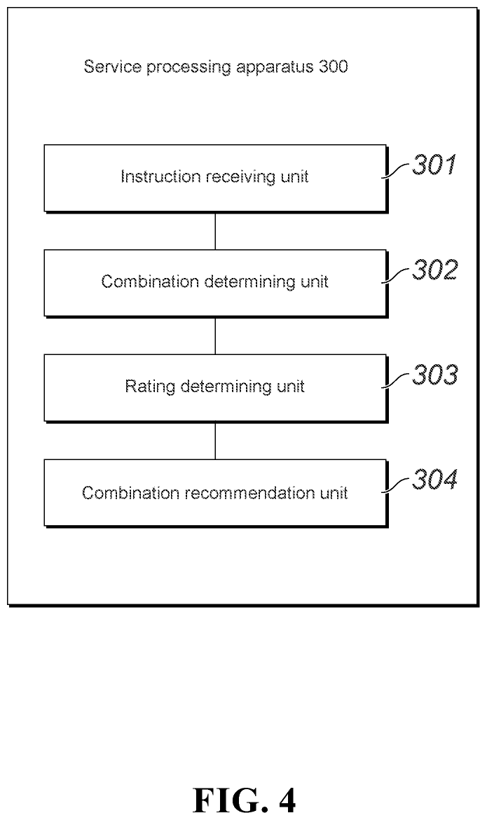

FIG. 4 is a structural diagram illustrating an example of a service processing apparatus, according to an example implementation of the present application.

Referring to FIG. 4, the service processing apparatus 300 can be applied to the serving terminal shown in FIG. 3, and includes an instruction receiving unit 301, a combination determining unit 302, a rating determining unit 303, and a combination recommendation unit 304.

The instruction receiving unit 301 receives a product order placed by a user, and the product order includes one or more product identifiers.

The combination determining unit 302 determines a supplier combination that matches the product identifiers, and the supplier combination includes one or more suppliers.

The rating determining unit 303 determines a recommendation rating of each supplier combination.

The combination recommendation unit 304 recommends, to the user, a supplier combination with a recommendation rating satisfying a predetermined condition.

Optionally, the combination determining unit 302 specifically determines a set of suppliers within a predetermined distance from a delivery address, and determines the supplier combination that matches the product identifiers from the set of suppliers.

Optionally, the recommendation rating includes a price recommendation rating and a review recommendation rating; and the combination recommendation unit 304 recommends, to the user, a first supplier combination with a price recommendation rating satisfying a first condition and a second supplier combination with a review recommendation rating satisfying a second condition.

Optionally, when the recommendation rating is a price recommendation rating, for products that correspond to all the product identifiers in the product order, the rating determining unit 303 calculates a difference between a quoted price and an average price of the supplier combination, and uses the difference as the price recommendation rating of the supplier combination.

Optionally, when the recommendation rating is a review recommendation rating, for products that correspond to all the product identifiers in the product order, the rating determining unit 303 obtains a product review score of the supplier combination, calculates an average review score of the supplier combination for all the products in the product order based on the product review score, and uses the average review score as the review recommendation rating of the supplier combination.

For implementation process steps and roles of each unit of the apparatus, reference can be made to corresponding process steps in the previous method descriptions. Details are not described here again to avoid duplication.

The apparatus implementations can correspond to the method implementations. Therefore, for related parts, reference can be made to descriptions in the method implementation. The described apparatus implementation is merely an example. The units described as separate parts may or may not be physically separate, and parts displayed as units may or may not be physical units, may be located in one position, or may be distributed on a plurality of network units. Some or all of the modules can be selected according to actual specifications to achieve the objectives of the technical solutions provided by the present application. A person of ordinary skill in the art may understand and implement the implementations without creative efforts.

The previous descriptions are merely examples of implementations of the present application, but are not intended to limit the present application. Any modification, equivalent replacement, or improvement made without departing from the spirit and principle of the present application should fall within the protection scope of the present application.

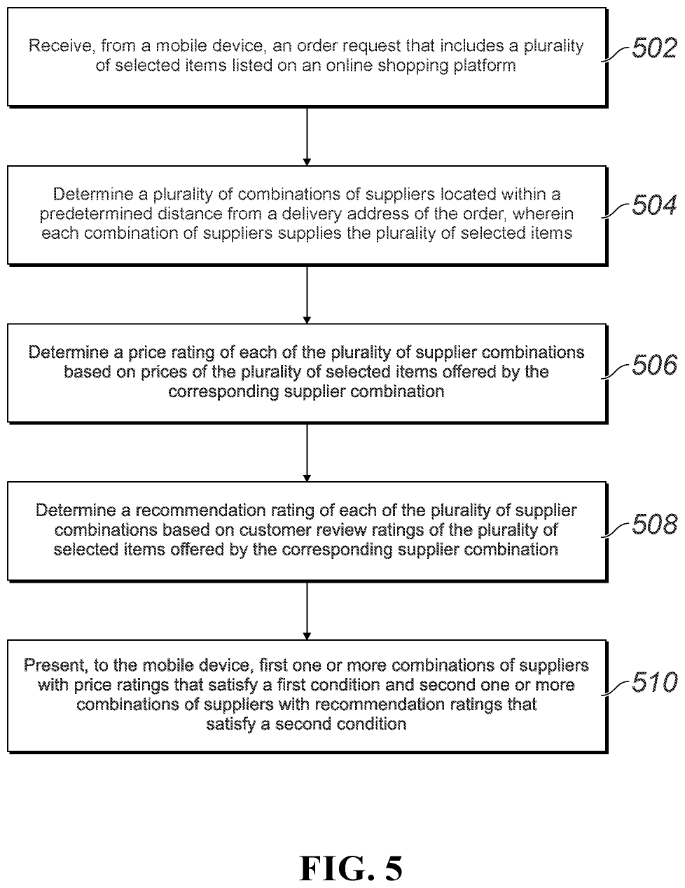

FIG. 5 is a flowchart illustrating an example of a computer-implemented method 500 for online shopping service processing, according to an implementation of the present disclosure. For clarity of presentation, the description that follows generally describes method 500 in the context of the other figures in this description. However, it will be understood that method 500 can be performed, for example, by any system, environment, software, and hardware, or a combination of systems, environments, software, and hardware, as appropriate. In some implementations, various steps of method 500 can be run in parallel, in combination, in loops, or in any order. In some cases, the method 500 can be performed by one or more servers that manage an online shopping platform.

At 502, an order request that includes a plurality of selected items listed on an online shopping platform is received from a mobile device. The online shopping platform can be a platform that carries any merchandise items such as consumer products and food products. The items listed on the online shopping platform can be supplied by a plurality of suppliers. To register on the platform, the suppliers can provide information such as registration address, supplier location, items offered and corresponding prices. Each item listed on the platform can have a corresponding item identifier. The items can be listed on the platform based on different categorization methods. For example, if the items are consumer products, they can be categorized into clothing, electronics, tools, books, etc. If the items are meals, they can be categorized based on types of food, cooking style, or flavors. A registered user of the online shopping platform can use a mobile device to visit the online shopping platform through a corresponding application. The user can select a plurality of items from items supplied by the plurality of suppliers listed on the online shopping platform. After the user made a selection of items, it can submit them as an order request that includes the item identifiers corresponding to the selected items. From 502, method 500 proceeds to 504.

At 504, a plurality of combinations of suppliers located within a predetermined distance from a delivery address of the order are determined, wherein each combination of suppliers supplies the plurality of selected items. Each supplier of each combination of suppliers supplies at least a portion of the plurality of selected items. In some implementations, a plurality of suppliers can be determined based on their proximity to the delivery address of the user who sent the order request. The delivery address can be entered by the user and included in the order request or it can be saved by the online shopping platform when the user entered the information during registration. In some implementations, the online shopping platform can calculate an estimated delivery time from different suppliers to the delivery address of the user and determine a plurality of combinations of suppliers that can deliver the items requested by the user within a predetermined time period. In some implementations, a limit on the number of suppliers can be set for the combination of suppliers. The number of suppliers in each supplier combination can be set to be a fixed number. Or the number of suppliers in each supplier combination can be set dynamically based on the number of items included in the order request. For example, the number of suppliers in the combination can be set as 3 or it can be set as less than the number of items included in the order request. From 504, method 500 proceeds to 506.

At 506, a price rating of each of the plurality of supplier combinations is determined based on prices of the plurality of selected items offered by the corresponding supplier combination. In some implementations, a total price or an average price of the items offered by each combination of suppliers can be calculated. A price rating for each combination of suppliers can be calculated based on the total price or average price of the items offered by the corresponding combination of suppliers. The lower the price, the higher the price rating of the corresponding supplier combination. In some implementations, a difference between the total price of the plurality of selected items offered by the corresponding supplier combination and the average total price of the plurality of selected items listed on the online shopping platform is calculated. For example, assume that the total price of the selected items offered by a corresponding supplier combination is X, and the average total price of the selected items listed on the platform is Y, the difference is then X-Y. The smaller the difference, the higher the price rating of the corresponding supplier combination. From 506, method 500 proceeds to 508.

At 508, a recommendation rating of each of the plurality of supplier combinations is determined based on customer review ratings of the plurality of selected items offered by the corresponding supplier combination. In some implementations, a total or an average customer review rating of the customer review ratings of the plurality of selected items are determined. The higher the total or average customer review rating, the higher the recommendation rating of the corresponding supplier combination. From 508, method 500 proceeds to 510.

At 510, first one or more combinations of suppliers with price ratings that satisfy a first condition and second one or more combinations of suppliers with recommendation ratings that satisfy a second condition are presented to the mobile device. In some implementations, the first condition or the second condition can be a number that limits the combinations of suppliers to be presented through the application of the mobile device. For example, there can be a condition that only the combinations of suppliers with the top 3 price ratings and recommendation ratings are presented to on the mobile device to the user. In some implementations, the first condition or the second condition can be a threshold, combinations of suppliers with price rating or recommendation that surpasses the threshold can be presented to the user. For example, a recommendation rating threshold can be set to 4.5 stars, which only dishes from combination of suppliers with average recommendation rating greater than equal to 4.5 stars are presented to the user. After 510, method 500 stops.

Implementations of the subject matter described in this specification can be implemented so as to realize particular advantages or technical effects. For example, implementations of the subject matter allows a uniform showing of the items available to be purchased. A user only need to select items he or she wants from a mobile computing device instead of navigating through different of suppliers of the items. Once the items are selected by the user, one or more combinations of suppliers that offer the selected items are automatically recommended to the user. As such, efficiency of online ordering can be improved and resource consumption by the mobile computing device can be reduced.

The described methodology permits enhancement of various mobile computing device transactions and overall transaction/data efficiency. Participants in transactions using mobile computing devices can more efficiently locate items from nearby suppliers that provide superior price and quality combinations.

The described methodology can ensure the efficient usage of computer resources (for example, processing cycles, network bandwidth, and memory usage), through the efficient management and organization of merchandise and suppliers on the online shopping platform. At least these actions can minimize or prevent waste of available computer resources with respect to multiple parties in a mobile computing transactions by reducing unnecessary user selection steps. Instead of users needing to visit different suppliers to select items, supplier combinations that provide best value can be automatically recommended to the users' superior user experience.

Embodiments and the operations described in this specification can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including by way of example a programmable processor, a computer, a system on a chip, or multiple ones, or combinations, of the foregoing. The apparatus can include special purpose logic circuitry, for example, a central processing unit (CPU), a field programmable gate array (FPGA) or an application-specific integrated circuit (ASIC). The apparatus can also include code that creates an execution environment for the computer program in question, for example, code that constitutes processor firmware, a protocol stack, a database management system, an operating system (for example an operating system or a combination of operating systems), a cross-platform runtime environment, a virtual machine, or a combination of one or more of them. The apparatus and execution environment can realize various different computing model infrastructures, such as web services, distributed computing and grid computing infrastructures.

A computer program (also known, for example, as a program, software, software application, software module, software unit, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be executed on one computer or on multiple computers that are located at one site or distributed across multiple sites and interconnected by a communication network.

Processors for execution of a computer program include, by way of example, both general- and special-purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data. A computer can be embedded in another device, for example, a mobile device, a personal digital assistant (PDA), a game console, a Global Positioning System (GPS) receiver, or a portable storage device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry.

Mobile devices can include handsets, user equipment (UE), mobile telephones (for example, smartphones), tablets, wearable devices (for example, smart watches and smart eyeglasses), implanted devices within the human body (for example, biosensors, cochlear implants), or other types of mobile devices. The mobile devices can communicate wirelessly (for example, using radio frequency (RF) signals) to various communication networks (described below). The mobile devices can include sensors for determining characteristics of the mobile device's current environment. The sensors can include cameras, microphones, proximity sensors, GPS sensors, motion sensors, accelerometers, ambient light sensors, moisture sensors, gyroscopes, compasses, barometers, fingerprint sensors, facial recognition systems, RF sensors (for example, Wi-Fi and cellular radios), thermal sensors, or other types of sensors. For example, the cameras can include a forward- or rear-facing camera with movable or fixed lenses, a flash, an image sensor, and an image processor. The camera can be a megapixel camera capable of capturing details for facial and/or iris recognition. The camera along with a data processor and authentication information stored in memory or accessed remotely can form a facial recognition system. The facial recognition system or one-or-more sensors, for example, microphones, motion sensors, accelerometers, GPS sensors, or RF sensors, can be used for user authentication.

To provide for interaction with a user, embodiments can be implemented on a computer having a display device and an input device, for example, a liquid crystal display (LCD) or organic light-emitting diode (OLED)/virtual-reality (VR)/augmented-reality (AR) display for displaying information to the user and a touchscreen, keyboard, and a pointing device by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments can be implemented using computing devices interconnected by any form or medium of wireline or wireless digital data communication (or combination thereof), for example, a communication network. Examples of interconnected devices are a client and a server generally remote from each other that typically interact through a communication network. A client, for example, a mobile device, can carry out transactions itself, with a server, or through a server, for example, performing buy, sell, pay, give, send, or loan transactions, or authorizing the same. Such transactions may be in real time such that an action and a response are temporally proximate; for example an individual perceives the action and the response occurring substantially simultaneously, the time difference for a response following the individual's action is less than 1 millisecond (ms) or less than 1 second (s), or the response is without intentional delay taking into account processing limitations of the system.

Examples of communication networks include a local area network (LAN), a radio access network (RAN), a metropolitan area network (MAN), and a wide area network (WAN). The communication network can include all or a portion of the Internet, another communication network, or a combination of communication networks. Information can be transmitted on the communication network according to various protocols and standards, including Long Term Evolution (LTE), 5G, IEEE 802, Internet Protocol (IP), or other protocols or combinations of protocols. The communication network can transmit voice, video, biometric, or authentication data, or other information between the connected computing devices.

Features described as separate implementations may be implemented, in combination, in a single implementation, while features described as a single implementation may be implemented in multiple implementations, separately, or in any suitable sub-combination. Operations described and claimed in a particular order should not be understood as requiring that the particular order, nor that all illustrated operations must be performed (some operations can be optional). As appropriate, multitasking or parallel-processing (or a combination of multitasking and parallel-processing) can be performed.

What is claimed is:

1. A computer-implemented method, comprising:
receiving, from a mobile device, an order request that includes a plurality of selected items listed on an online shopping platform;
determining a plurality of combinations of suppliers located within a predetermined distance from a delivery address of the order, wherein each combination of suppliers supplies the plurality of selected items;
determining a price rating of each of the plurality of supplier combinations based on prices of the plurality of selected items offered by the corresponding supplier combination;
determining a recommendation rating of each of the plurality of supplier combinations based on customer review ratings of the plurality of selected items offered by the corresponding supplier combination; and
presenting, to the mobile device, first one or more combinations of suppliers with price ratings that satisfy a first condition and second one or more combinations of suppliers with recommendation ratings that satisfy a second condition.

2. The computer-implemented method of claim 1, wherein the plurality of selected items correspond to a plurality of item identifiers, and the order request includes the plurality of item identifiers.

3. The computer-implemented method of claim 1, wherein a number of suppliers in each supplier combination is less than a predetermined threshold, wherein the predetermined threshold is less than a number of the plurality of selected items in the order request.

4. The computer-implemented method of claim 1, wherein the determining of the price rating of each of the plurality of supplier combinations further includes determining a difference between the total price of the plurality of selected items offered by the corresponding supplier combination and the average total price of the plurality of selected items listed on the online shopping platform.

5. The computer-implemented method of claim 1, wherein the determining of the recommendation rating of each of the plurality of supplier combinations further includes determining an average customer review rating of the customer review ratings of the plurality of selected items.

6. The computer-implemented method of claim 1, wherein the first condition is satisfied if the price rating is greater than or equal to a first predetermined threshold and the second condition is satisfied if the recommendation rating is greater than or equal to a second predetermined threshold.

7. The computer-implemented method of claim 1, wherein the first condition is satisfied if each of the first one or more combinations of suppliers has higher price rating than rest of the plurality of combinations of suppliers, and each of the second one or more combinations of suppliers has higher recommendation rating than rest of the plurality of combinations of suppliers.

8. A non-transitory, computer-readable medium storing one or more instructions executable by a computer system to perform operations comprising:
receiving, from a mobile device, an order request that includes a plurality of selected items listed on an online shopping platform;
determining a plurality of combinations of suppliers located within a predetermined distance from a delivery address of the order, wherein each combination of suppliers supplies the plurality of selected items;
determining a price rating of each of the plurality of supplier combinations based on prices of the plurality of selected items offered by the corresponding supplier combination;
determining a recommendation rating of each of the plurality of supplier combinations based on customer review ratings of the plurality of selected items offered by the corresponding supplier combination; and
presenting, to the mobile device, first one or more combinations of suppliers with price ratings that satisfy a first condition and second one or more combinations of suppliers with recommendation ratings that satisfy a second condition.

9. The non-transitory, computer-readable medium of claim 8, wherein the plurality of selected items correspond to a plurality of item identifiers, and the order request includes the plurality of item identifiers.

10. The non-transitory, computer-readable medium of claim 8, wherein a number of suppliers in each supplier combination is less than a predetermined threshold, wherein the predetermined threshold is less than a number of the plurality of selected items in the order request.

11. The non-transitory, computer-readable medium of claim 8, wherein the determining of the price rating of each of the plurality of supplier combinations further includes determining a difference between the total price of the plurality of selected items offered by the corresponding supplier combination and the average total price of the plurality of selected items listed on the online shopping platform.

12. The non-transitory, computer-readable medium of claim 8, wherein the determining of the recommendation rating of each of the plurality of supplier combinations further includes determining an average customer review rating of the customer review ratings of the plurality of selected items.

13. The non-transitory, computer-readable medium of claim 8, wherein the first condition is satisfied if the price rating is greater than or equal to a first predetermined threshold and the second condition is satisfied if the recommendation rating is greater than or equal to a second predetermined threshold.

14. The non-transitory, computer-readable medium of claim 8, wherein the first condition is satisfied if each of the first one or more combinations of suppliers has higher price rating than rest of the plurality of combinations of suppliers, and each of the second one or more combinations of suppliers has higher recommendation rating than rest of the plurality of combinations of suppliers.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving, from a mobile device, an order request that includes a plurality of selected items listed on an online shopping platform;
determining a plurality of combinations of suppliers located within a predetermined distance from a delivery address of the order, wherein each combination of suppliers supplies the plurality of selected items;
determining a price rating of each of the plurality of supplier combinations based on prices of the plurality of selected items offered by the corresponding supplier combination;
determining a recommendation rating of each of the plurality of supplier combinations based on customer review ratings of the plurality of selected items offered by the corresponding supplier combination; and
presenting, to the mobile device, first one or more combinations of suppliers with price ratings that satisfy a first condition and second one or more combinations of suppliers with recommendation ratings that satisfy a second condition.

16. The computer-implemented system of claim 15, wherein the plurality of selected items correspond to a plurality of item identifiers, and the order request includes the plurality of item identifiers.

17. The computer-implemented system of claim 15, wherein a number of suppliers in each supplier combination is less than a predetermined threshold, wherein the predetermined threshold is less than a number of the plurality of selected items in the order request.

18. The computer-implemented system of claim 15, wherein the determining of the price rating of each of the plurality of supplier combinations further includes determining a difference between the total price of the plurality of selected items offered by the corresponding supplier combination and the average total price of the plurality of selected items listed on the online shopping platform.

19. The computer-implemented system of claim 15, wherein the determining of the recommendation rating of each of the plurality of supplier combinations further includes determining an average customer review rating of the customer review ratings of the plurality of selected items.

20. The computer-implemented system of claim 15, wherein:
the first condition is satisfied if the price rating is greater than or equal to a first predetermined threshold and the second condition is satisfied if the recommendation rating is greater than or equal to a second predetermined threshold; or
the first condition is satisfied if each of the first one or more combinations of suppliers has higher price rating than rest of the plurality of combinations of suppliers, and each of the second one or more combinations of suppliers has higher recommendation rating than rest of the plurality of combinations of suppliers.
